(19) United States
(12) Patent Application Publication
(10) Pub. No.: US 2023/0104710 A1
(43) Pub. Date: Apr. 6, 2023

(54) MAGNETIC DOCKING SYSTEM

(71) Applicant: Eli ZHADANOV, Brooklyn, NY (US)

(72) Inventor: Eli ZHADANOV, Brooklyn, NY (US)

(21) Appl. No.: 17/936,678

(22) Filed: Sep. 29, 2022

Related U.S. Application Data
(60) Provisional application No. 63/262,043, filed on Oct. 4, 2021.

(51) Int. Cl. B05B 1/18; B05B 15/62

(52) U.S. Cl. CPC B05B 1/185; B05B 15/62

(57) ABSTRACT

A shower head system includes a head portion extending from a first end to a second end, the second end including a first surface having a first shape and a second surface having a second shape; a cradle having a connecting end, the connecting end including a third surface shaped to correspond to the first surface and a fourth surface shaped to correspond to the second surface; and a coupling mechanism including at least one first element and at least one second element. The head portion is movable between (a) a docked configuration in which the second end of the head portion is removably coupled to the connecting end of the cradle via the coupling mechanism and (b) an unlocked configuration in which the head portion is separated from the cradle. When the head portion is the docked configuration, (a) the first surface mates with the third surface and (b) one of the second and fourth surfaces is received by the other one of the second and fourth surfaces. The first element is positioned adjacent to at least a portion of one of the first surface and the second surface, the second element being positioned adjacent to at least a portion of one of the third surface and the fourth surface. When the first element is positioned adjacent to at least the portion of the first surface, the second element is positioned adjacent to at least the portion of the third surface. When the first element is positioned adjacent to at least the portion of the second surface, the second element is positioned adjacent to at least the portion of the fourth surface. At least one of the first and second elements is composed of a magnetic material.

### PRIORITY CLAIM

The preset disclosure claims priority to U.S. Provisional Patent Application Ser. No. 63/262,043 filed Oct. 4, 2021; the disclosure of which is incorporated herewith by reference.

### FIELD

The present disclosure relates to a handheld shower system with a magnetic docking.

### BACKGROUND

A conventional handheld shower with a magnetic docking system is known. In order to connect the conventional hand shower to a conventional cradle, the user must perfectly align a magnet or a magnetic element on the back of the handheld shower with a magnet or a magnetic element on a front of the cradle. However, it is often difficult for the user to guide the conventional handheld shower into the conventional cradle to achieve such alignment.

### SUMMARY

The present disclosure relates to a shower head system. The system includes a head portion extending from a first end to a second end, the second end including a first surface having a first shape and a second surface having a second shape; a cradle having a connecting end, the connecting end including a third surface shaped to correspond to the first surface and a fourth surface shaped to correspond to the second surface; and a coupling mechanism including at least one first element and at least one second element. The head portion is movable between (a) a docked configuration in which the second end of the head portion is removably coupled to the connecting end of the cradle via the coupling mechanism and (b) an undocked configuration in which the head portion is separated from the cradle. When the head portion is the docked configuration, (a) the first surface mates with the third surface and (b) one of the second and fourth surfaces is received by the other one of the second and fourth surfaces. The first element is positioned adjacent to at least a portion of one of the first surface and the second surface, the second element being positioned adjacent to at least a portion of one of the third surface and the fourth surface. When the first element is positioned adjacent to at least the portion of the first surface, the second element is positioned adjacent to at least the portion of the third surface. When the first element is positioned adjacent to at least the portion of the second surface, the second element is positioned adjacent to at least the portion of the fourth surface. At least one of the first and second elements is composed of a magnetic material.

In addition, the present disclosure relates to a shower head system. The system has a head portion extending from a first end to a second end, the second end including a first surface including a head feature that is one of a depression and a projection and a surrounding portion surrounding the head feature. Also, the system includes a cradle having a connecting end forming a second surface shaped to mate with the first surface when the head portion is mounted on the cradle in a desired position. The second surface includes a cradle feature including one of a depression and a projection that is shaped to mate with the head feature and a surrounding portion surrounding the cradle feature. Furthermore, the system includes a coupling mechanism including a first element mounted within the surrounding portion of the head portion adjacent to the first surface and a second element mounted within the surrounding portion of the cradle adjacent to the second surface. The first and second elements magnetically couple to one another so that, when the second surface of the cradle is positioned adjacent to the first surface of the head portion, the first and second elements couple the head portion to the cradle so that the mating of the head feature with the cradle feature aligns the head portion and the cradle in the desired position.

### BRIEF DESCRIPTION

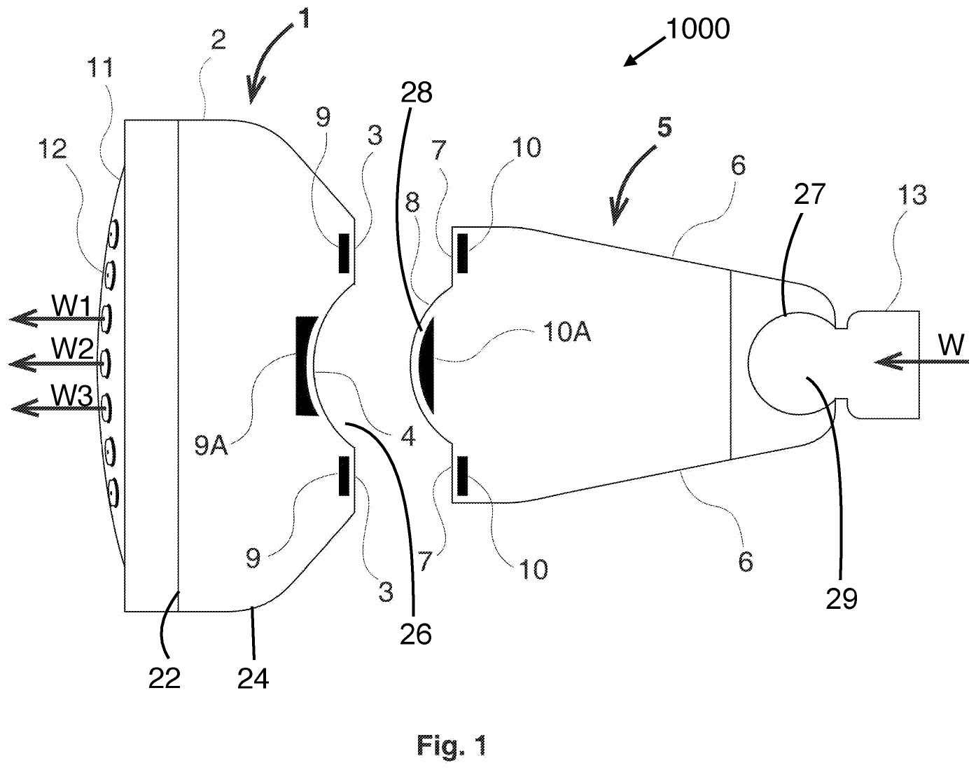

FIG. 1 shows a top view of an undocked configuration of a magnetic docking system according to an exemplary embodiment of the present disclosure.

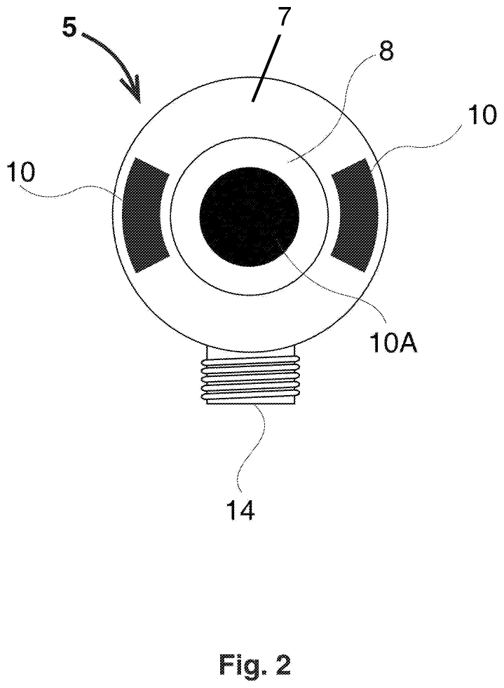

FIG. 2 shows a front view of an exemplary embodiment of a cradle of the magnetic docking system of FIG. 1.

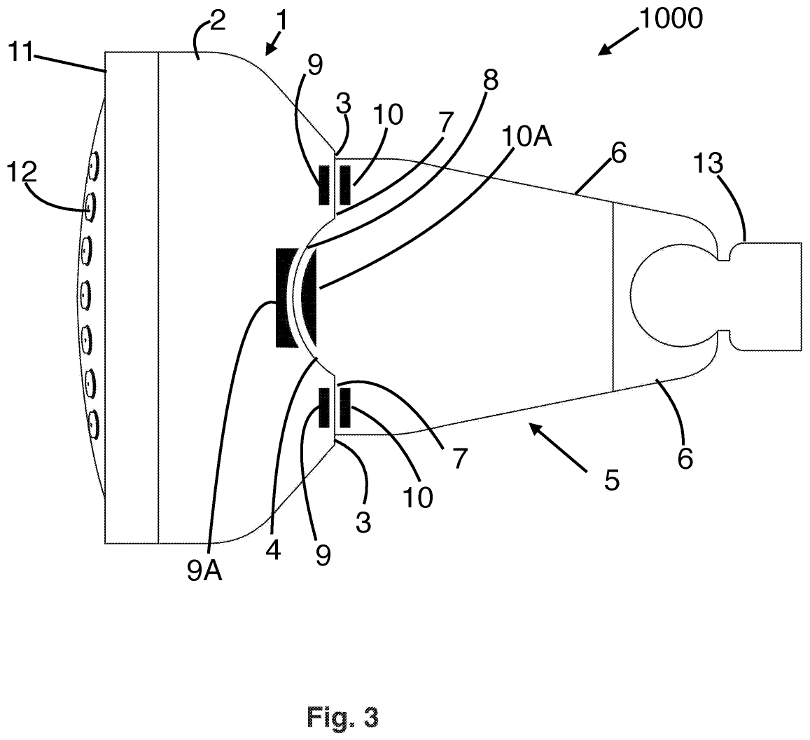

FIG. 3 shows a top view of a docked configuration of the magnetic docking system of FIG. 1.

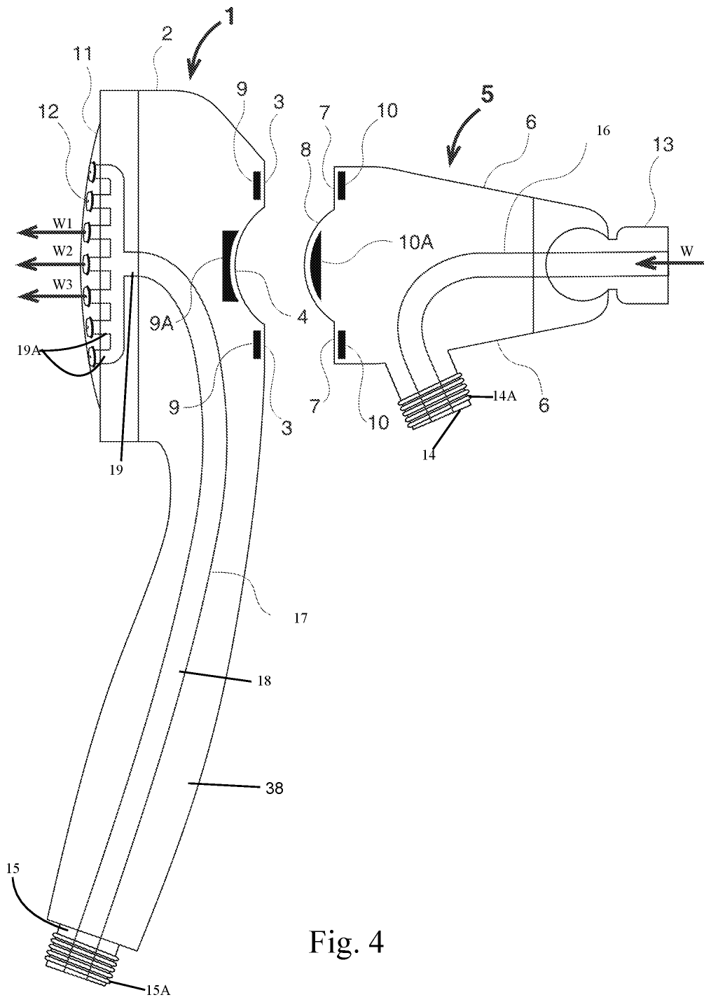

FIG. 4 shows a side view of the undocked configuration of the magnetic docking system of FIG. 1.

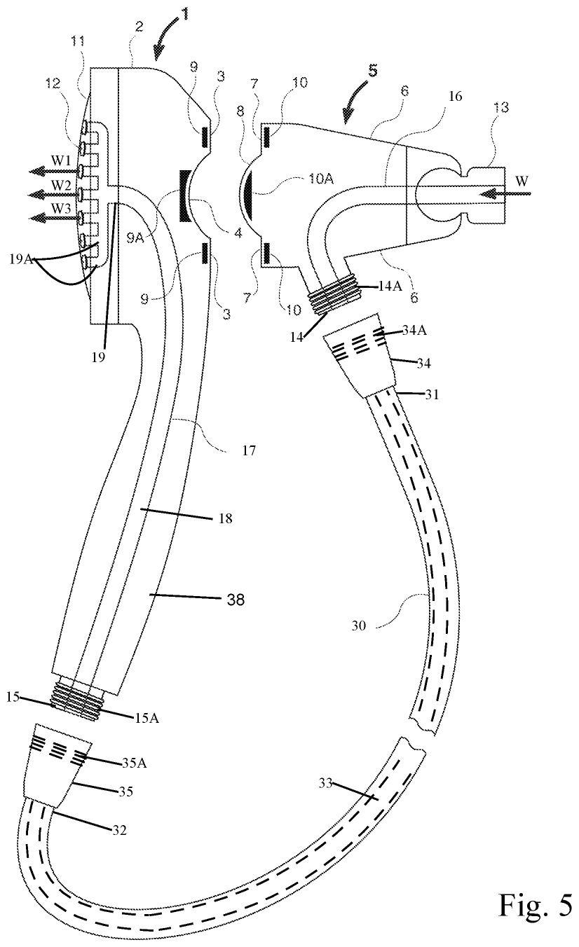

FIG. 5 shows a side view of the undocked configuration of the magnetic docking system of FIG. 1 having a shower hose.

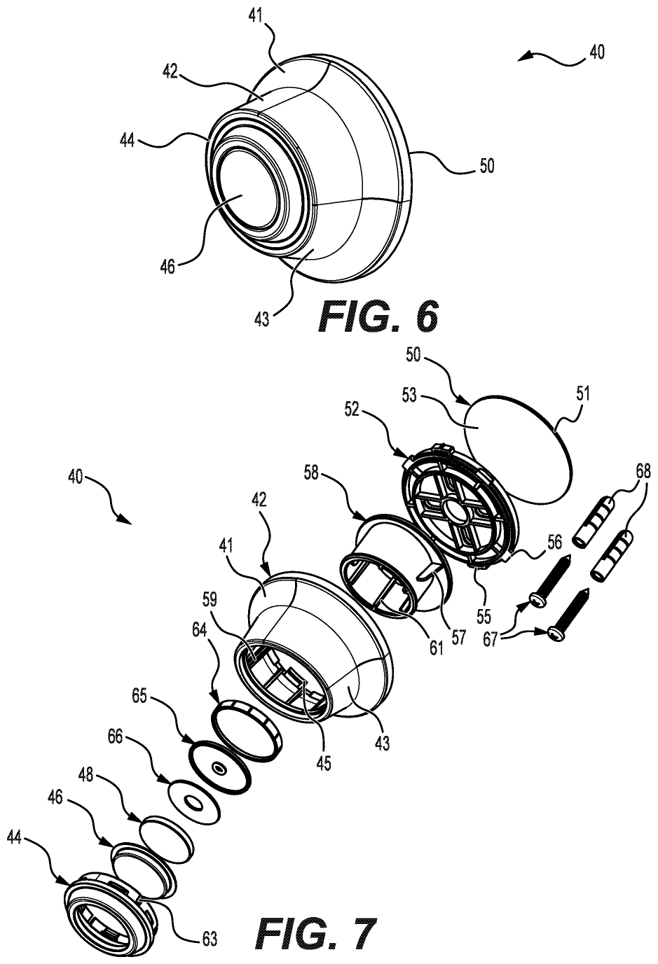

FIG. 6 shows a perspective view of an exemplary embodiment of a shower head holder of the magnetic docking system of FIG. 1.

FIG. 7 shows an exploded view of the shower head holder of FIG. 6.

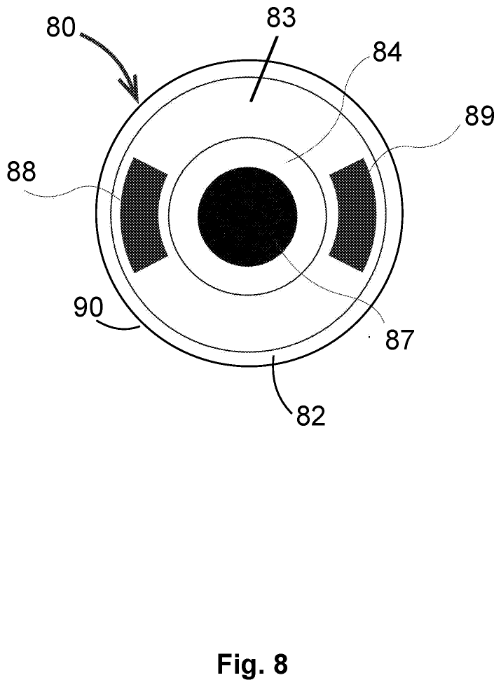

FIG. 8 shows a front view of another exemplary embodiment of a shower head holder of the magnetic docking system of FIG. 1.

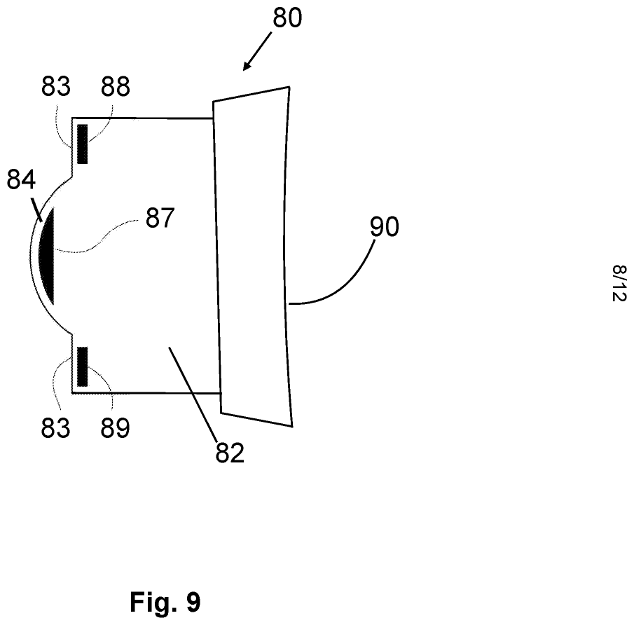

FIG. 9 shows a side view of the shower head holder of FIG. 8.

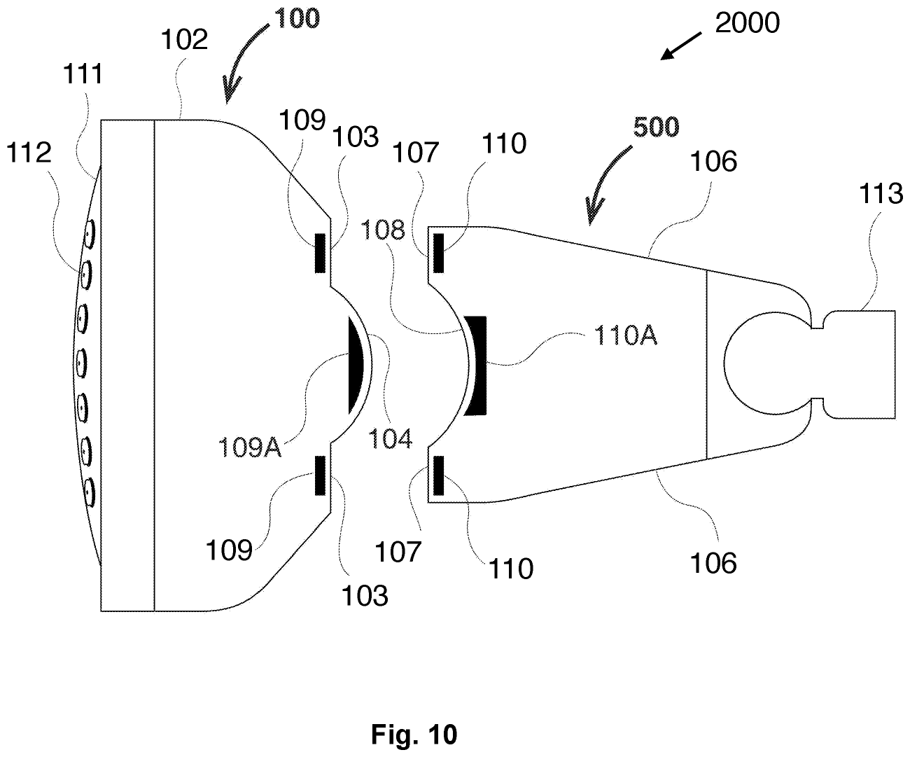

FIG. 10 shows a top view of an undocked configuration of a magnetic docking system according to another exemplary embodiment of the present disclosure.

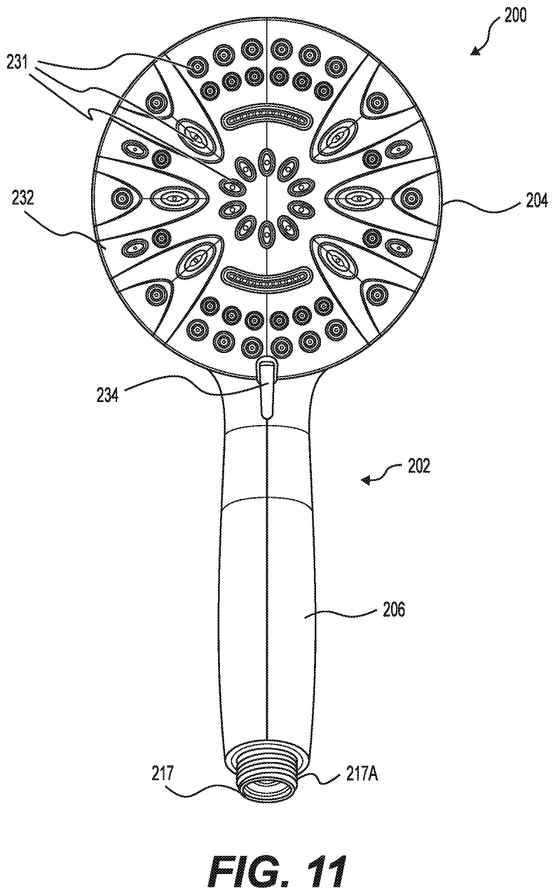

FIG. 11 shows a front view of a shower head according to yet another exemplary embodiment of the present disclosure.

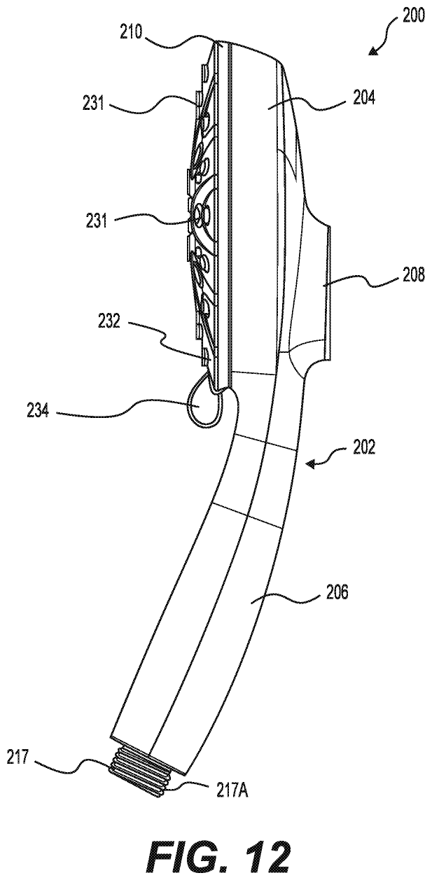

FIG. 12 shows a side view of the shower head of FIG. 9.

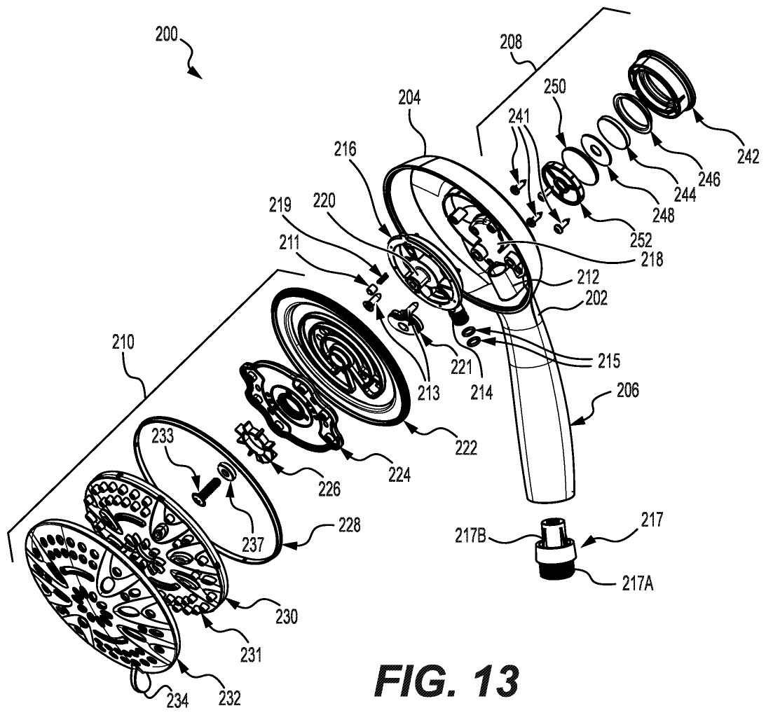

FIG. 13 shows an exploded view of the shower head of FIG. 9.

### DETAILED DESCRIPTION

FIGS. 1-7 show a magnetic docking system 1000 according to an exemplary embodiment according of the present disclosure. The system 1000 includes an arrangement of elements of the shower head and/or the cradle demonstrating how they would align and engage with one another for a docking process.

In particular, FIG. 1 shows the system 1000 which may include a shower head 1 and a cradle 5. The shower head 1 may include a head housing 2 with a first surface 3, a second surface 4, at least one first element 9 and at least one second element 9A. In addition, the shower head 1 may include a front face plate 11 with nozzles 12 through which shower water is dispersed at a user and a handle 38 that may be held by the user to move the shower head 1.

The first surface 3 may be a substantially flat surface shape (e.g., the first surface 3 may be flat). However, according to other exemplary embodiments, the shape of the first surface 3 may be slight oval and/or round. The second surface 4 may be a substantially rounded shape and/or a substantially oval shape (e.g., the second surface 4 may be substantially concave). However, those skilled in the art would understand that the second surface 4 may be another shape (e.g., a substantially square or rectangular shape, etc.) or a combination of shapes.

The first element 9 may be located anywhere on the first surface 3 or, as shown in FIG. 1, below the first surface 3. In an alternative exemplary embodiment, the first surface 3 may have an opening (not shown) so that the first element 9 may be partially located below the first surface 3 and protruding through and from the first surface 3. In a further alternative exemplary embodiment, the first element 9 may be attached to the first surface 3, such that no portion of the first element 9 is below the first surface 3, the first element 9 being protected from the shower water by any technique known to one with ordinary skill in the art. Although FIG. 1 shows a width of the first element 9 being less than a width of the first surface 3 (e.g., the first element 9 only extends along a portion of the shower head 1 under the first surface 3 such that an area coverage of the first element 9 is less than an area coverage of the first surface 3), those skilled in the art would understand that the area coverage of the first element 9 may be between 5% and 100% of the area coverage of the first surface 3.

The second element 9A may be located anywhere on the second surface 4 or, as shown in FIG. 1, below the second surface 4. In an alternative exemplary embodiment, the second surface 4 may have an opening (not shown) so that the second element 9A may be partially located below the second surface 4 and protruding through and from the second surface 4. In a further alternative exemplary embodiment, the second element 9A may be attached to the second surface 4, such that no portion of the second element 9A is below the second surface 4, the second element 9A being protected from the shower water by any technique known to one with ordinary skill in the art. Although FIG. 1 shows a width of the second element 9A being less than a width of the second surface 4 (e.g., the second element 9A only extends along a portion of the shower head 1 under the second surface 4 such that an area coverage of the second element 9A is less than an area coverage of the second surface 4), those skilled in the art would understand that the area coverage of the second element 9A may be between 5% and 100% of the area coverage of the second surface 4.

The cradle 5 may include a cradle housing 6 with a third surface 7, a fourth surface 8, at least one third element 10 and at least one fourth element 10A. FIG. 1 shows a connection arrangement (e.g., a ball joint nut 13) which connects the cradle 5 to a source of water W (not shown) such as a shower pipe or a shower arm. The ball joint nut 13 is comprised of a ball end 29 that is sized and shaped to be inserted into a cavity 27 of the cradle 5. In an exemplary embodiment, the ball end 29 may be configured to pivot relative to the cavity 27.

The third surface 7 may be a substantially flat surface shape (e.g., the third surface 7 may be flat). However, according to other exemplary embodiments, the shape of the third surface 7 may be slight oval and/or round. The fourth surface 8 may be a substantially rounded shape and/or a substantially oval shape (e.g., the fourth surface 8 may be substantially convex). However, those skilled in the art would understand that the fourth surface 8 may be another shape or a combination of shapes (e.g., a substantially square or rectangular shape, etc.).

According to the exemplary embodiment of the present disclosure, the shape of the first surface 3 may substantially or partially compliment the shape of the third surface 7. However, according to alternative exemplary embodiments, only a portion of the first surface 3 has a shape which compliments the shape of the third surface 7. Alternatively, only a portion of the third surface 7 has a shape which compliments the shape of the first surface 3.

According to the exemplary embodiment of the present disclosure, the shape of the second surface 4 may substantially or partially compliment the shape of the fourth surface 8 such that the fourth surface 8 is received by the second surface 4. However, according to alternative exemplary embodiments, only a portion of the second surface 4 has a shape which compliments the shape of the fourth surface 8. Alternatively, only a portion of the fourth surface 8 has a shape which compliments the shape of the second surface 4.

The third element 10 may be located anywhere on the third surface 7 or, as shown in FIG. 1, below the third surface 7. In an alternative exemplary embodiment, the third surface 7 may have an opening (not shown) so that the third element 10 may be partially located below the third surface 7 and protruding through and from the third surface 7. In a further alternative exemplary embodiment, the third element 10 may be attached to the third surface 7, such that no portion of the third element 10 is below the third surface 7, the third element 10 being protected from the shower water by any technique known to one with ordinary skill in the art. Although FIG. 1 shows a width of the third element 10 being less than a width of the third surface 7 (e.g., the third element 10 only extends along a portion of the cradle 5 under the third surface 7 such that an area coverage of the third element 10 is less than an area coverage of the third surface 7), those skilled in the art would understand that the area coverage of the third element 10 may be between 5% and 100% of the area coverage of the third surface 7.

The fourth element 10A may be located anywhere on the fourth surface 8 or, as shown in FIG. 1, below the fourth surface 8. In alternative exemplary embodiment, the fourth surface 8 may have an opening (not shown) so that the fourth element 10A may be partially located below the fourth surface 8 and protruding through and from the fourth surface 8. In a further alternative exemplary embodiment, the fourth element 10A may be attached to the fourth surface 8, such that no portion of the fourth element 10A is below the fourth surface 8, the fourth element 10A being protected from the shower water by any technique known to one with ordinary skill in the art. Although FIG. 1 shows a width of the fourth element 10A being less than a width of the fourth surface 8 (e.g., the fourth element 10A only extends along a portion of the cradle 5 under the fourth surface 8 such that an area coverage of the fourth element 10A is less than an area coverage of the fourth surface 8), those skilled in the art would understand that the area coverage of the fourth element 10A may be between 5% and 100% of the area coverage of the fourth surface 8.

According to the exemplary embodiment of the present disclosure, the system 1000 of FIG. 1 utilizes the first element 9, the second element 9A, the third element 10 and the fourth element 10A. However, according to an alternative exemplary embodiment of the present disclosure (not shown), the system 1000 may include only the first element 9 and the third element 10; alternatively, the system 1000 may include only the second element 9A and the fourth element 10A.

According to one exemplary embodiment, the first, second, third and fourth elements 9, 9A, 10, 10A are composed of a magnetic material (e.g., the first, second, third and fourth elements 9, 9A, 10, 10A are magnets). According to another exemplary embodiment only one of the second element 9A and the fourth element 10A is composed of the magnetic material; the other one is composed of a ferromagnetic material that is attracted by the magnetic material (e.g., iron, nickel, cobalt, etc.). In another exemplary embodiment, only one of the first element 9 and the third element 10 is composed of the magnetic material; the other one is composed of the ferromagnetic material.

In a further exemplary embodiment, the first element 9 and the fourth element 10A are composed of the magnetic material and the second element 9A and third element 10 are composed of the ferromagnetic material. In addition, in another exemplary embodiment, the second element 9A and the third element 10 are composed of the magnetic material and the first element 9 and the fourth element 10A are composed of the ferromagnetic material.

According to an exemplary embodiment, each pair of counter-opposing elements (e.g., the first element 9 and the third element 10 being a first pair and the second element 9A and the fourth element 10A being a second pair) may include either (a) a combination of two elements composed of the magnetic material or (b) one element composed of the magnetic material and the other element in the pair composed of the ferromagnetic material.

Yet in another exemplary embodiment (not shown), the shower head 1 includes the first element 9 composed of the magnetic material, while the cradle 5 does not include the third element 10, instead, the third surface 7 of the cradle 5 is composed of the ferromagnetic material. In a further exemplary embodiment (not shown), the cradle 5 includes the third element 10 composed of the magnetic material, while the shower head 1 does not include the first element 9, instead, the first surface 3 of the shower head 1 is composed of the ferromagnetic material.

In a further exemplary embodiment (not shown), the shower head 1 includes the second element 9A composed of the magnetic material, while the cradle 5 does not include the fourth element 10A, instead, the fourth surface 8 of the cradle 5 is composed of the ferromagnetic material. In a further exemplary embodiment (not shown), the cradle 5 includes the fourth element 10A composed of the magnetic material, while the shower head 1 does not include the second element 9A, instead, the second surface 4 of the shower head 1 is composed of the ferromagnetic material.

Yet in another exemplary embodiment (not shown), the shower head 1 includes the first element 9 composed of the magnetic material and the cradle 5 includes the fourth element 10A also composed of the magnetic material. However, the shower head 1 does not include the second element 9A, instead the second surface 4 of the shower head 1 is composed of the ferromagnetic material. In addition, the cradle 5 does not have the third element 10, instead the third surface 7 of the cradle 5 is composed of the ferromagnetic material.

In a further exemplary embodiment (not shown), the shower head 1 includes the second element 9A composed of the magnetic material and the cradle 5 includes the third element 10 also composed of the magnetic material. However, the shower head 1 does not include the first element 9, instead the first surface 3 of the shower head 1 is composed of the ferromagnetic material. In addition, the cradle 5 does not include the fourth element 10A, instead the fourth surface 8 of the cradle 5 is composed of the ferromagnetic material.

In the exemplary embodiment, each of the first surface 3 and the third surface 7 is substantially annulus-shaped while the second surface 4 and the fourth surface 8 are shaped to fill the corresponding annulus of the first surface 3 and the third surface 7, respectively. The third element 10 may be a single element sized and shaped to correspond to the annulus shape of the third surface 7 or, as shown in FIG. 2, the third element 10 may be composed of a plurality of smaller third elements 10. In particular, FIG. 2 shows a front view of the cradle 5 having two third elements 10 on opposite sides of the third surface 7. The two third elements 10 are substantially similar in shape and size to have similar coupling (e.g., magnetic) force associated with each of them. The number of third elements 10 of the cradle 5 may correspond to the number of first elements 9 of the shower head 1. FIG. 2 further shows the cradle 5 having a singular fourth element 10A, the shape of the fourth element 10A may correspond to the shape of the second element 9A to ease coupling of the second element 9A to the fourth element 10A.

As shown in FIG. 2, a cross-section of the third element 10 is smaller than a cross-section of the third surface 7, such that the third element 10 covers less surface area than the third surface 7. In a further embodiment, however, the cross-section of the third element 10 may be substantially the same as the cross-section of the third surface 7 to increase the coupling surface area of the third element 10. Similarly, a cross-section of the fourth element 10A is smaller than a cross-section of the fourth surface 8, such that the fourth element 10A covers less surface area than the fourth surface 8. In a further embodiment, however, the cross-section of the fourth element 10A may be substantially the same as the cross-section of the fourth surface 8 to increase the coupling surface area of the fourth element 10A.

In the exemplary embodiment, the head housing 2 is substantially frustum-like in shape. The head housing 2 extends from a first end 22 to a second end which includes the first surface 3. The first end 22 is coupled to the front face plate 11. The head housing 2 tapers from an edge 24 toward the first surface 3, the edge 24 being approximately midway between the first end 22 and the first surface 3. The head housing 2 further may include a cavity 26 sized and shaped to accommodate a correspondingly shaped bulge 28 of the cradle 5, the bulge 28 having the fourth element 10A under the fourth surface 8. The bulge is substantially spherical in shape. Although the head housing 2 is described in the embodiment as being substantially frustum-like in shape and having the cavity 26, in further embodiments, the head housing 2 and the bulge 28 may have different shapes.

FIGS. 4 and 5 show side views of the system 1000 in the undocked configuration. The system 1000 may include at least one shower hose 30 which extends from a first end 31 to a second end 32. The shower hose 30 may include a shower hose lumen 33 extending therethrough and connecting the cradle 5 to the shower head 1. The system 1000 is configured to supply shower water from a shower water source (e.g., water pipes) to the user. The shower water is supplied from the water source (not shown) through a cradle channel 16 extending at least partially through the cradle 5. The cradle channel 16 extends from a first end connected to the water source to a second end at an outlet 14 of the cradle 5. As shown in FIGS. 2 and 4, the outlet 14 may have a threading 14A extending circumferentially about an exterior surface of the outlet 14, the threading 14A corresponding to a threading 34A of the shower hose 30. The shower hose 30 may include a first connection part 34 at the first end 31 and a second connection part 35 at the second end 32, the first connection part 34 having the threading 34A extending circumferentially about an interior surface thereof. The threading 34A is configured to correspond to the threading 14A to create a water-tight seal between the first connection part 34 and the outlet 14 such that the shower water passes through the cradle channel 16 into the shower hose lumen 33.

Similarly to the first connection part 34, the second connection part 35 has a threading 35A extending circumferentially about an interior surface thereof. The threading 35A are configured to correspond to a threading 15A of an inlet 15 of the shower head 1 to create a water-tight seal between the second connection part 35 and the inlet 15 such that the shower water passes through the shower hose lumen 33 into a shower head channel 17. The shower head channel 17 including a first portion 18 extending through the shower head 1 from a first end at the inlet 15 to a second end and a second portion 19 extending from the second end of the first portion 18 to a plurality of nozzle outlets 19A. Each of the plurality of nozzle outlets 19A are configured to supply the shower water from the first portion 18 of the shower head channel 17 to the user through a corresponding one of the nozzles 12. The nozzle outlets 19A extend through the face plate. As one with ordinary skill in the art will understand, although the threadings 14A, 15A, 34A, and 35A are used in the exemplary embodiment for attaching the shower head 1 to the cradle 5 via the shower hose 30, the shower hose 30 may attach to the shower head 1 and the cradle 5 via any coupling method that produces a water-tight seal to transport shower water without the shower water escaping.

Arrows W, W1, W2, W3 shown in FIGS. 1, 4 and 5 show a path of the shower water from the water source through the cradle 5 (e.g., the straight arrow W), through the shower hose 30, through the shower head 1, and out of the shower head 1 (e.g., the straight arrows W1-W3) via the nozzles 12. Although FIGS. 1, 4 and 5 only show three straight arrows W1-W3 extending out of three of the nozzles 12, one with ordinary skill in the art will understand that the shower water may be dispersed out of the shower head 1 through all or fewer than all of the nozzles 12.

As mentioned above, the first surface 3, the second surface 4, the first element 9 and/or the second element 9A of the shower head 1 are arranged to at least partially correspond to the third surface 7, the fourth surface 8, the third element 10 and/or the fourth element 10A of the cradle 5, respectively. For example, the first surface 3 of the shower head 1 may be arranged substantially opposite to or partially opposite to the third surface 7 of the cradle 5. Similarly, the second surface 4 of the shower head 1 may be arranged substantially opposite to or partially opposite to the fourth surface 8 of the cradle 5, the first element 9 of the shower head 1 may be arranged substantially opposite to or partially opposite to the third element 10 of the cradle 5, and the second element 9A of the shower head 1 may be arranged substantially opposite to or partially opposite to the fourth element 10A of the cradle 5.

While FIG. 1 shows the system 1000 in an undocked mode in which the shower head 1 is separated from the cradle 5, FIG. 3 shows the system 1000 in the docked mode in which the shower head 1 is attached to the cradle 5. For example, in the docked mode, the shower head 1 is detachably docked (e.g., detachably attached) to the cradle 5. During the docking process (i.e., when the system 1000 is switched from the undocked mode to the docked mode), the second surface 4 of the shower head 1 comes in at least partial contact with the fourth surface 8 of the cradle 5, such that the second surface 4 receives at least part of the fourth surface 8. The second surface 4 receives at least part of the fourth surface 8 to prevent the second surface 4 from slipping relative to the fourth surface 8. Preventing the second surface 4 from slipping relative to the fourth surface 8 prevents the second surface 4 from being separated prematurely and possibly falling and injuring the user of the system 1000.

In an exemplary embodiment of the present disclosure, the shapes of the second surface 4 and the fourth surface 8 guide the user toward the docked mode. When the user moves a portion of the cavity 26 of the shower head 1 into contact with a portion of the bulge 28 of the cradle 5, a curvature (e.g., the second surface 4) of the cavity 26 slides along a curvature (e.g., the fourth surface 8) of the bulge 28 and guides the system 1000 into the docked mode. The curvature of the cavity 26 may substantially match the curvature of the bulge 28. Once the cavity 26 and the bulge 28 are in full contact with each other (i.e., the cavity 26 is no longer slidable relative to the bulge 28), the first surface 3, the third surface 7, the first element 9, the second element 9A, the third element 10 and the fourth element 10A become substantially aligned to detachably dock the shower head 1 to the cradle 5.

Once the shower head 1 docks with the cradle 5, the shower head 1 becomes securely coupled to the cradle 5. In other words, once docked, the shower head 1 may only be undocked from the cradle 5 when the user applies a predetermined pulling force on the shower head 1 to separate the first surface 3 from the third surface 7 and the second surface 4 from the fourth surface 8. The predetermined pulling force is greater than a force necessary to dock the shower head 1 to the cradle 5 to prevent the shower head 1 from undocking and separating from the cradle 5 prematurely (i.e., without the user applying the predetermined pulling force).

FIGS. 6 and 7 show an exemplary embodiment of a shower head holder 40 of the system 1000. The holder 40 is configured to attach to the shower head 1 and hold the shower head 1 in a location different from a location of the cradle 5. The holder 40 provides the user with the flexibility to separate the shower head 1 from the cradle 5 and place the shower head 1 at least one different location. The holder 40 may include a body 42, a shelf 44, a cap 46, a coupling element 48 and an adhesive element 50. The body 42 may include a portion 41 and a substantially cylindrical portion 43. The portion 41 may include a locking mechanism configured to “lock” a board 52 relative to the portion 41. In the exemplary, the locking mechanism may include a plurality of tabs 45 extending longitudinally from the portion 41. \

The board 52 is configured to includes a plurality of openings 55, each of the openings 55 configured to receive a corresponding one of the tabs 45 of the portion 41 to lock the board 52 relative to the portion 41. The adhesive element 50 (e.g., a sticker, a suction cup) may include a first surface 51 attachable to any surface (e.g., a wall, a tile, a pane of glass) of the shower and a second surface 53 attachable to the board 52. In an exemplary embodiment, the adhesive element 50 may be attached and detached from any surface, allowing the user to place the holder 40 in different locations. Further, the board 52 may have protrusions 56 that the user may apply a force onto to separate the holder 40 from the surface to which the holder 40 was attached.

The body 42 may be further configured to house an inlay 58. The inlay 58 includes a plurality of exterior wings 57, each of the exterior wings 57 being sized and shaped to be received by body grooves 59 extending longitudinally about an interior of the cylindrical portion 43 of the body 42. The inlay 58 further may include a plurality of interior wings 61, each of the interior wings 61 being sized and shaped to be received by shelf grooves 63 of the shelf 44. Each of the shelf grooves 63 is configured to rest on a top portion of a respective one of the interior wings 61. In an exemplary embodiment, the shelf 44 may include a locking mechanism configured to “lock” the shelf 44 relative to the body 42 and the inlay 58.

In the exemplary embodiment, the shelf 44 may be further configured to receive a first ring 64, a second ring 65, a washer 66 and the cap 46. The first ring 64 may be configured to receive the second ring 65, which in turn, may be configured to receive the washer 66. The cap 46 is sized and shaped to house the coupling element 48 and to protect the coupling element 48 from being damaged by the shower water. The coupling element 48 (e.g., a magnet) is configured to couple to the second element 9A of the shower head 1 in a similar manner to the second element 9A being coupled to the fourth element 10A of the cradle 5. In an exemplary embodiment, the holder 40 may further include a plurality of screws 67 configured to be inserted into screw sockets 68 to attach the holder 40 to a wall.

During the docking process (i.e., when the shower head 1 is moved into contact with the holder 40 to dock the shower head 1 onto the holder 40), the second surface 4 of the shower head 1 comes in at least partial contact with the cap 46, and thus, the coupling element 48 of the holder 40, such that the second surface 4 receives at least part of the cap 46 and coupling element 48.

FIGS. 8, 9 show a further exemplary embodiment of a shower head holder 80 of the system 1000. The shower head holder 80 is configured to attach the shower head 1 to a wall in a substantially similar manner as the holder 40. The holder 80 is substantially similar to the holder 40 as the holder 80 includes a body 82, a first coupling element 87, a second coupling element 88, a third coupling element 89 and an adhesive element 90. As opposed to the holder 40 of FIG. 6 which includes a singular coupling element 48, the holder 80 of FIG. 8 includes at least two coupling elements (e.g., the first, second, and third coupling elements 87, 88, 89). The holder 80 further includes a first surface 83 configured to correspond to the first surface 3 of the shower head 1 and a second surface 84 configured to correspond to the second surface 4 of the shower head 1. Similar to the third coupling element 10 and the fourth coupling element 10A of the cradle 5, the first and the second coupling elements 87, 88 may be below the first surface 83 of the holder 80 and the third coupling element 89 may be below the second surface 84 of the holder 80. As one with ordinary skill in the art will understand, a front face of the holder 80 (shown in FIG. 9, a front view of the holder 80) is substantially similar to a front face of the cradle 5 (shown in FIG. 2, the front view of the cradle 5), to improve coupling between the shower head 1 and the holder 80.

During the docking process (i.e., when the shower head 1 is moved into contact with the holder 80 to dock the shower head 1 onto the holder 80), the second surface 4 of the shower head 1 comes in at least partial contact with the second surface 84 of the holder 80, such that the second surface 4 receives at least part of the second surface 84. As one with ordinary skill in the art will ascertain, the shapes of the second surface 4 and the second surface 84 may guide the user during the docking process. When the user moves a portion of the second surface 4 of the shower head 1 into contact with a portion of the second surface 4 of the holder 80, the second surface 4 slides along the second surface 84 and guides the shower head 1 to dock with the holder 80. Once the second surfaces 4, 84 are in full contact with each other (i.e., the second surface 4 is no longer slidable relative to the second surface 84), the first surface 3, the first element 9, and the second element 9A (e.g., two second elements 9A) become substantially aligned with the first surface 83, the first coupling element 87, the second coupling element 88 and the third coupling element 89, respectively, to detachably dock the shower head 1 to the holder 80.

Once the shower head 1 docks with the holder 80, the shower head 1 becomes securely coupled to the holder 80. In other words, once docked, the shower head 1 may only be undocked from the holder 80 when the user applies a predetermined pulling force on the shower head 1 to separate the first surface 3 from the first surface 83 and the second surface 4 from the second surface 84. The predetermined pulling force is greater than a force necessary to dock the shower head 1 to the holder 80 to prevent the shower head 1 from undocking and separating from the holder 80 prematurely (i.e., without the user applying the predetermined pulling force). Although this exemplary embodiment shows three coupling elements (e.g., the first, second, and third coupling elements 87, 88, 89), the holder 80 may have any number of coupling elements as long as the coupling elements at least partially align with and couple to the first element 9 and the second element 9A of the shower head 1 to couple the shower head 1 to the holder 80.

FIG. 10 shows a magnetic docking system 2000 according to another exemplary embodiment of the present disclosure. The system 2000 is substantially similar to the system 1000 except as will be described below.

In particular, a shower head 100 of the system 2000 is substantially similar the shower head 1 of the system 1000 as the shower head 100 includes a head housing 102 and a front face plate 111, the head housing 102 having a first surface 103, a second surface 104, at least one first element 109, and at least one second element 109A, and the front face plate 111 having nozzles 112. Accordingly, the shower head 100 is substantially similar to the shower head 1, except that the second surface 104 and the second element 109A of the shower head 100 differ in shape from the second surface 4 and the second element 9A, respectively, of the shower head 1. Further, a cradle 500 of the system 2000 is substantially similar to the cradle 5 of the system 1000 as the cradle 500 includes a cradle housing 106 having a third surface 107, a fourth surface 108, at least one third element 110 and at least one fourth element 110A. Accordingly, the cradle 500 is substantially similar to the cradle 5, except that the fourth surface 108 and the fourth element 110A of the cradle 500 differ in shape from the fourth surface 8 and the fourth element 10A, respectively, of the cradle 5. The system 2000 further includes a ball joint nut 113 which connects the cradle 500 to a source of water (not shown) such as a shower pipe or a shower arm.

The second surface 104 may be a substantially rounded shape and/or a substantially oval shape (e.g., the second surface 104 may be substantially convex). However, those skilled in the art would understand that the second surface 104 may be another shape or a combination of shapes (e.g., a substantially square or rectangular shape, etc.).

The second element 109A may be located anywhere on the second surface 104 or, as shown in FIG. 10, below the second surface 104. In alternative exemplary embodiment, the second surface 104 may have an opening (not shown) so that the second element 109A may be partially located below the second surface 104 and protruding through and from the second surface 104. Although FIG. 10 shows a width of the second element 109A being less than a width of the second surface 104 (e.g., the second element 109A only extends along a portion of the shower head 100 under the second surface 104 such that an area coverage of the second element 109A is less than an area coverage of the second surface 104), those skilled in the art would understand that the area coverage of the second element 109A may be between 5% and 100% of the area coverage of the second surface 104.

The fourth surface 108 may be a substantially rounded shape and/or a substantially oval shape (e.g., the fourth surface 108 may be substantially concave). However, those skilled in the art would understand that the fourth surface 108 may be another shape (e.g., a substantially square or rectangular shape, etc.) or a combination of shapes.

According to the exemplary embodiment of the present disclosure, the shape of the second surface 104 may substantially or partially compliment the shape of the fourth surface 108. However, according to alternative exemplary embodiments, only a portion of the second surface 104 has a shape which compliments the shape of the fourth surface 108. Alternatively, only a portion of the fourth surface 108 has a shape which compliments the shape of the second surface 104.

The fourth element 110A may be located anywhere on the fourth surface 108 or, as shown in FIG. 10, below the fourth surface 108. In alternative exemplary embodiment, the fourth surface 108 may have an opening (not shown) so that the fourth element 110A may be partially located below the fourth surface 108 and protruding through and from the fourth surface 108. Although FIG. 10 shows a width of the fourth element 110A being less than a width of the fourth surface 108 (e.g., the fourth element 110A only extends along a portion of the cradle 500 under the fourth surface 108 such that an area coverage of the fourth element 110A is less than an area coverage of the fourth surface 108), those skilled in the art would understand that the area coverage of the fourth element 110A may be between 5% and 100% of the area coverage of the fourth surface 108.

According to the exemplary embodiment of the present disclosure, the system 2000 of FIG. 9 utilizes the first element 109, the second element 109A, the third element 110, and the fourth element 110A. However, according to alternative exemplary embodiments of the present disclosure (not shown), the system 2000 may include only the first element 109 and the third element 110 or the system 2000 may include only the second element 109A and the fourth element 110A.

FIG. 10 shows the system 2000 in an undocked mode. The docking process of switching from the undocked mode to the docket mode for the shower head 100 and the cradle 500 is substantially similar the docking process of the shower head 1 and the cradle 5. In the docked mode, the shower head 100 is detachably docked (e.g., detachably attached) to the cradle 500. During the docking process (i.e., when the system switched from the undocked mode to the docked mode), the second surface 104 comes in at least partial contact with the fourth surface 108. In an exemplary embodiment of the present disclosure, the shapes of the second surface 104 and the fourth surface 108 guide the user towards the docked mode. Subsequently, the first surface 103, the third surface 107, the first element 109, the second element 109A, the third element 110 and/or the fourth element 110A become substantially aligned to detachably dock the shower head 100 to the cradle 500.

FIGS. 11-13 show a shower head 200 according to another exemplary embodiment of the present disclosure. The shower head 200 is substantially similar to the shower heads 1, 100 except as will be described below.

In the exemplary embodiment, the shower head 200 may include a body 202 having a head portion 204 and a handle portion 206, a coupling mechanism 208 and a face plate 210. The head portion 204 may include a socket 212 configured to receive a neck 214 of a board 216, the board 216 sized and shaped to be inserted into a correspondingly shaped opening 218 of the head portion 204. In the exemplary embodiment, the neck 214 may include a threading 214A extending about an exterior surface of the neck 214, the threading 214A corresponding a threading 212A extending about an interior surface of the socket 212. The shower head 200 may further include at least one O-ring 215 configured to be slide over the threading 214A of the neck 214 to insert the neck 214 into the socket 212 and to prevent shower water from escaping. The board 216 further includes a hollow protrusion 220 extending outward from a center of the board 216. The board 216 is further attached to the head portion 204 via screws 213, a marble 211 inserted onto a spring 219, and a washer 221.

In the exemplary embodiment, the handle portion 206 is substantially hollow and extends from a first end to a second end. The second end of the handle portion 206 is configured to receive an inlet 217 therein. The inlet 217 is substantially hollow and may include a threading 217A to which a shower hose (e.g., a shower hose similar to the shower hose 30) may attach to provide the shower water from a shower water source (not shown). The inlet 217 may further include a plurality of wings 217B, the wings 217B sized and shaped to be inserted into corresponding shaped grooves (not shown) extending along an interior of the second end of the handle portion 206 to lock the inlet 217 relative to the handle portion 206. Although the exemplary embodiment shows a snap-fit mechanism for locking the inlet 217 relative to the handle portion 206, one with ordinary skill in the art will understand that any other locking method (e.g., threading) may be used to lock the inlet 217 relative to the handle portion 206.

In the exemplary embodiment, the coupling mechanism 208 is configured to attach to the head portion 204 via a plurality of screws 241. The coupling mechanism 208 is composed of a coupling base 242 housing a coupling element 244, a coupling cap 246, a washer 248, a seal washer 250, and an inlay 252. The coupling element 244 (e.g., a magnet) is sized and shaped to be inserted into the coupling cap 246 to protect the coupling element 244 from being damaged by the shower water. The seal washer 250 is then inserted over the washer 248 into the coupling cap 246 to further protect the coupling element 244 and the inlay 252 is then inserted over the coupling cap 246 into the coupling base 242. Although in the exemplary embodiment the coupling mechanism 208 is attached to the head portion 204 via the screws 241, in a further exemplary embodiment, the coupling mechanism 208 may be attached to the head portion 204 via a different attaching method, or the coupling mechanism 208 may be formed integrally with the head portion 204.

In the exemplary embodiment, the face plate 210 comprises a housing 222, platform 224, a rotator 226, a ring 228, an inner shower face 230 having a plurality of nozzles 231 and an outer shower face 232. The housing 222 is configured to house the platform 224, the rotator 226, the ring 228 and at least a portion of the inner shower face 230. The platform 224 is sized and shaped to be inserted into the housing 222. The rotator 226, which permits rotation of the inner shower face 230 about an axis relative to the head housing 204, is inserted onto the platform 224. The ring 228 is then inserted into the housing 222 and the at least a portion of the inner shower face 230 is inserted into the ring 228. The housing 222, the platform 224 and the rotator 226 are locked relative to each other and are attached to the board 216 via a screw 233 inserted through a washer and into the hollow protrusion 220 of the board 216. The threading of the screw 233 matches the threading of the hollow protrusion 220 to create a snug fit. The outer shower face 232 snap-fits over the inner shower face 230 and includes a gripper 234 extending therefrom that permits the user to rotate the outer shower face 232 and the inner shower face 230 about an axis relative to the head portion 204.

One of advantages of the present disclosure is that the magnetic docking system provides a convenient way for the user to attach a handheld shower to a cradle for a hands-free showering and a storage. The present disclosure allows for an improved alignment and/or connection between the handheld shower and the cradle. The receiving element of the present disclosure also prevents a shower head from prematurely separating from a cradle and harming a user.

The present disclosure is illustrated and described in reference to a particular embodiment, however it includes other alternative embodiments, alterations and modifications generated by anyone skilled in the art.

1. A shower head system, comprising:
a head portion extending from a first end to a second end, the second end including a first surface having a first shape and a second surface having a second shape;
a cradle having a connecting end, the connecting end including a third surface shaped to correspond to the first surface and a fourth surface shaped to correspond to the second surface; and
a coupling mechanism including at least one first element and at least one second to element,
wherein the head portion is movable between (a) a docked configuration in which the second end of the head portion is removably coupled to the connecting end of the cradle via the coupling mechanism and (b) an unlocked configuration in which the head portion is separated from the cradle,
wherein when the head portion is the docked configuration, (a) the first surface mates with the third surface and (b) one of the second and fourth surfaces is received by the other one of the second and fourth surfaces,
wherein the first element is positioned adjacent to at least a portion of one of the first surface and the second surface, the second element being positioned adjacent to at least a portion of one of the third surface and the fourth surface,
wherein when the first element is positioned adjacent to at least the portion of the first surface, the second element is positioned adjacent to at least the portion of the third surface,
wherein when the first element is positioned adjacent to at least the portion of the second surface, the second element is positioned adjacent to at least the portion of the fourth surface, and
wherein at least one of the first and second elements is composed of a magnetic material.

2. The shower head system of claim 1, wherein one of the first and second elements is composed of a ferro-magnetic material.

3. The shower head system of claim 1, wherein the coupling mechanism includes a third element and a fourth element, wherein at least one of the third and fourth elements is composed of the magnetic material, wherein when the first element is positioned adjacent to at least the portion of the first surface, the third element is positioned adjacent to at least the portion of the second surface, and wherein when the second element is positioned adjacent to at least the portion of the third surface, the fourth element is positioned adjacent to at least the portion of the fourth surface.

4. The shower head system of claim 1, wherein the first element is at least partially situated inside of the head portion and the second element is at least partially situated inside of the cradle.

5. The shower head system of claim 1, wherein the first element is at least partially situated outside of the head portion and the second element is at least partially situated outside of the cradle.

6. The shower head system of claim 1, wherein a portion of at least one of the first, second, third and fourth surfaces is composed of a ferromagnetic material.

7. The shower head system of claim 1, wherein the head portion includes a handle for a user.

8. The shower head system of claim 1, wherein the first and third surfaces are substantially planar.

9. The shower head system of claim 1, wherein one of the second and fourth surfaces is convex and the other one of the second and fourth surfaces is concave.

10. The shower head system of claim 8, wherein each of the second and fourth surfaces are formed as part of a sphere.

11. The shower head system of claim 1, wherein the fourth surface extends outward from the connecting end of the cradle to create a bulge, the bulge being sized and shaped to be inserted into a correspondingly sized and shaped cavity formed by the second surface of the second end of the head portion.

12. The shower head system of claim 1, wherein the cradle includes an opening to receive water, the shower head system further comprising:
a shower head holder configured to receive the head portion, the holder including
a body extending from a first end to a second end;
at least one fifth element; and
an attachment element configured to attach the first end of the body to a surface,
wherein the second end of the body includes a fifth surface shaped to correspond to the first surface and a sixth surface shaped to correspond to the second surface; and
wherein the head portion is movable between (a) a further docked configuration in which the second end of the head portion is removably coupled to the second end of the holder via the first element and the second element and (b) a further undocked configuration in which the head portion is separated from the holder,
wherein when the head portion is the further docked configuration, (a) the first surface mates with the fifth surface and (b) one of the second and sixth surfaces is received by the other one of the second and sixth surfaces,
wherein the fifth element is positioned adjacent to at least a portion of one of the fifth surface and the sixth surface,
wherein when the first element is positioned adjacent to at least the portion of the first surface, the fifth element is positioned adjacent to at least the portion of the fifth surface,
wherein when the first element is positioned adjacent to at least, the portion of the second surface, the fifth element is positioned adjacent to at least the portion of the sixth surface,
wherein at least one of the first and fifth elements is composed of the magnetic material, and
wherein the holder lacks an opening to receive water.

13. The shower head system of claim 12, wherein the coupling mechanism further comprises a third element positioned adjacent to at least the portion of the second surface, the shower head holder further comprising:
a sixth element positioned adjacent to at least the portion of the sixth surface,
wherein when the head portion is moved into the further docked configuration, the first element couples with the fifth element and the third element couples with the sixth element such that (a) the first surface mates with the fifth surface and (b) one of the second and sixth surfaces is received by the other one of the second and sixth surfaces,
wherein at least one of the first and fifth elements is composed of the magnetic material, and
wherein at least one of the third and sixth elements is composed of the magnetic material.

14. A shower head system, comprising:
a head portion extending from a first end to a second end, the second end including a first surface including a head feature that is one of a depression and a projection and a surrounding portion surrounding the head feature;
a cradle having a connecting end forming a second surface shaped to mate with the first surface when the head portion is mounted on the cradle in a desired position, the second surface including a cradle feature including one of a depression and a projection that is shaped to mate with the head feature and a surrounding portion surrounding the cradle feature; and
a coupling mechanism including a first element mounted within the surrounding portion of the head portion adjacent to the first surface and a second element mounted within the surrounding portion of the cradle adjacent to the second surface, the first and second elements magnetically coupling to one another so that, when the second surface of the cradle is positioned adjacent to the first surface of the head portion, the first and second elements couple the head portion to the cradle so that the mating of the head feature with the cradle feature aligns the head portion and the cradle in the desired position.

15. The shower head system of claim 14, wherein the coupling mechanism includes a third element mounted within the head feature adjacent to the first surface and a fourth element mounted within the cradle feature adjacent to the second surface, the third and fourth elements magnetically coupling to one another so that, when the second surface of the cradle is positioned adjacent to the first surface of the head portion, the first, second, third and fourth elements couple the cradle to the head portion so that the mating of the head feature with the cradle feature aligns the cradle and the head portion in the desired position.

16. The shower head system of claim 14, wherein the first element is at least partially situated inside of the surrounding portion of the head portion and the second element is at least partially situated inside of the surrounding portion of the cradle.

17. The shower head system of claim 14, wherein a portion of at least one of the first and second surfaces is composed of a ferromagnetic material.

18. The shower head system of claim 14, wherein one of the head and cradle features is convex and the other one of the head and cradle features is concave.

19. The shower head system of claim 18, wherein each one of the head and cradle features are formed as part of a sphere.

20. The shower head system of claim 14, wherein the cradle includes an opening to receive water, the shower head system further comprising:
a shower head holder configured to receive the head portion, the holder including
a body extending from a first end to a second end;
at least one fifth element; and
an attachment element configured to attach the first end of the body to a surface,
wherein the second end of the body includes a third surface shaped to mate with the first surface when the head portion is mounted on the holder in a desired configuration, the third surface including a holder feature that is one of a depression and a projection and a surrounding portion surrounding the holder feature,
wherein the at least one fifth element is mounted within the surrounding portion of the holder adjacent to the third surface, the first and at least one fifth elements magnetically coupling to one another so that, when the third surface of the holder is positioned adjacent to the first surface of the head portion, the first and at least one fifth elements couple the head portion to the holder so that mating of the head feature with the holder feature aligns the head portion and the holder in the desired configuration, and
wherein the holder lacks an opening to receive water.
